(19) United States
(12) Patent Application Publication
(10) Pub. No.: US 2013/0119930 A1
(43) Pub. Date: May 16, 2013

(54) RESONANCE TYPE NON-CONTACT POWER SUPPLY SYSTEM

(71) Applicants: Shimpei Sakoda, Kariya-shi (JP); Kazuyoshi Takada, Kiriya-shi (JP); Shinji Ichikawa, Toyota-shi (JP)

(72) Inventors: Shimpei Sakoda, Kariya-shi (JP); Kazuyoshi Takada, Kiriya-shi (JP); Shinji Ichikawa, Toyota-shi (JP)

(21) Appl. No.: 13/811,551

(22) PCT Filed: Jul. 28, 2011
(86) PCT No.: PCT/JP2011/004280

§ 371 Date: Jan. 22, 2013

(30) Foreign Application Priority Data
Jul. 29, 2010 (JP) 2010-170595

(51) Int. Cl. H04B 5/00; B60L 11/18

(52) U.S. Cl. CPC H04B 5/0037; B60L 11/182
USPC 320/108; 307/104; 307/9.1

(57) ABSTRACT

A resonance type non-contact power supply system that supplies power through a primary resonance coil and a secondary resonance coil. The resonance type non-contact power supply system includes power supplying equipment and movable body equipment. The power supplying equipment includes a primary coil unit, which is provided with the primary resonance coil, and a distance detector, which detects the distance between the primary and secondary resonance coils. The movable body equipment includes a switch and a terminal resistor. When the distance detector detects the distance, the switch connects the terminal resistor to the secondary coil unit and disconnects a rectifier and power storage device from a secondary coil unit. When the movable body equipment receives power, the switch connects the rectifier and the power storage device to the secondary coil unit and disconnects the terminal resistor from the secondary coil unit.

### TECHNICAL FIELD

The present invention relates to a resonance type non-contact power supply system, and more particularly, to a resonance type non-contact power supply system desirable for use when charging a power storage device of a movable body in a non-contact manner.

### BACKGROUND ART

PTL 1 describes a charging system for a vehicle. The charging system uses resonance to charge a power storage device, which is installed in the vehicle, with power received from a power supply located outside the vehicle in a wireless manner. More specifically, the charging system of the above document includes an electric vehicle and a power supplying device. The electric vehicle includes a secondary self-resonance coil (secondary resonance coil), a secondary coil, a rectifier, and the power storage device. The power supplying device includes a high-frequency power driver, a primary coil, and a primary self-resonance coil (primary resonance coil). The number of windings in the secondary self-resonance coil is determined based on the voltage of the power storage device, the distance between the primary and secondary self-resonance coils, and the resonant frequency of the primary and secondary self-resonance coils. The distance between the power supply device and the vehicle changes depending on the situation of the vehicle, such as, the weight of the vehicle and the air pressure of the tires. Changes in the distance between the primary self-resonance coil of the power supply device and the secondary self-resonance coil of the vehicle varies the resonant frequency of the primary and secondary self-resonance coils. Thus, a variable capacitor is connected between the conductive wires of the secondary self-resonance coil. When charging the power storage device, the charging system calculates the charging power for the power storage device based on the detections of a voltage sensor and a current sensor and adjusts the capacitance of the variable capacitor to maximize the charging power. This adjusts the LC resonant frequency of the secondary self-resonance coil.

### CITATION LIST

### Patent Literature

PTL 1: Japanese Laid-Open Patent Publication No. 2009-106136

### SUMMARY OF INVENTION

### Technical Problem

PTL 1 discloses a process that efficiently supplies power from a power supplying side to a power receiving side even when the situation of the vehicle changes the distance between the primary and secondary self-resonance coils. When the power storage device is charged, this process adjusts the capacitance of the variable capacitor for the secondary self-resonance coil to maximize the charging power for the power storage device. However, in this process, the charging power for the power storage device is calculated based on the detections of the voltage and current sensors, and the capacitance of the variable capacitor must be adjusted until the charging power is maximized.

Further, in this process, it is assumed that the distance between the primary and secondary self-resonance coils changes depending on the situation of the vehicle in a state in which the vehicle is parked at the proper charging position. Since the vehicle is parked at the predetermined charging position, there is no mention of detection of the distance between the primary resonance coil, which supplies power, and the secondary resonance coil, which receives power.

The distance between the primary and secondary resonance coils may be detected by measuring the impedance of the resonance system. As long as the distance between the primary and secondary resonance coils can be detected, a matching unit can be used to finely adjust the power supply system to a state in which power is efficiently supplied from the power supplying side to the power receiving side. However, during the distance detection, when the matching unit, a charger, or a rechargeable battery is connected to the resonance system, changes in the state of charge of the rechargeable battery hinder accurate distance detection. As a result, power cannot be efficiently supplied from the power supplying side to the power receiving side.

It is an objective of the present invention to provide a resonance type non-contact power supply system that accurately detects the distance between a primary resonance coil, which supplies power, and a secondary resonance coil, which is installed in a movable body that receives the power, to efficiently supply power from the power supplying primary resonance coil to the power receiving secondary resonance coil.

### Solution to Problem

To achieve the above object, the present invention provides a resonance type non-contact power supply system that supplies power through a primary resonance coil and a secondary resonance coil. The resonance type non-contact power supply system includes power supplying equipment and movable body equipment. The power supplying equipment includes an AC power supply, a primary coil unit, which includes the primary resonance coil that receives power from the AC power supply, and a distance detector, which detects the distance between the primary resonance coil and the secondary resonance coil. The movable body equipment includes a secondary coil unit, which includes the secondary resonance coil that receives power from the primary resonance coil, a rectifier, which rectifies the power received by the secondary resonance coil, a power storage device, which is supplied with the power rectified by the rectifier, a switch, and a terminal resistor, which is connectable by the switch to the secondary coil unit. When the distance detector detects the distance, the switch connects the terminal resistor to the secondary coil unit and disconnects the rectifier and the power storage device from the secondary coil unit. When the movable body equipment receives power, the switch connects the rectifier and the power storage device to the secondary coil unit and disconnects the terminal resistor from the secondary coil unit.

Here, a state connected to the secondary coil unit by the switch includes a case in which the switch directly connects the terminal resistor to the secondary coil and a case in which the switch connects the terminal resistor to the secondary coil unit with a circuit element (e.g., secondary matching unit) arranged between the switch and the secondary coil unit. Further, the secondary coil unit refers to coils used at a secondary side when the movable body equipment receives power through the primary resonance coil. The secondary coil unit includes at least the secondary resonance coil. Further, the secondary coil unit is formed by only the secondary resonance coil or by a combination of the secondary resonance coil and a secondary coil, which is coupled to the secondary resonance coil through electromagnetic induction.

In this invention, the power supplying equipment detects the distance between the primary resonance coil and the secondary resonance coil. When the power supplying equipment detects the distance between the primary and secondary resonance coils, for example, the input impedance of the resonance system is measured to detect distance. The resonance system includes the primary resonance coil, a circuit element (e.g., matching unit or primary coil) arranged between the AC power supply and the primary resonance coil, the secondary resonance coil, and a circuit element electrically connected to the secondary resonance coil. That is, when the secondary coil unit is connected to the terminal resistor, the resonance system in the movable body equipment includes the secondary coil unit, the terminal resistor, and a circuit component (e.g., matching unit) arranged between the secondary coil unit and the terminal resistor. When the secondary coil unit is connected to the rectifier and the power storage device, the resonance system in the movable body equipment includes the secondary coil unit, the rectifier, the power storage device, and the circuit element (e.g., matching unit) arranged between the secondary coil unit and the rectifier. The input impedance of the resonance system refers to the impedance of the entire resonance system (primary coil unit and secondary coil unit) measured across two terminals of the primary coil unit, which receives alternating current during distance detection. When distance detection is performed, the terminal resistor arranged in the movable body equipment is connected by the switch to the secondary coil unit. Further, the rectifier and the power storage device are disconnected from the secondary coil unit. When the input impedance of the resonance system is measured in a state in which the rectifier and the power storage device are connected to the secondary coil unit, the distance cannot be accurately detected if the power storage device is a rechargeable battery due to changes in the state of charge of the rechargeable battery. As a result, power cannot be efficiently supplied from the power supplying side to the power receiving side. However, the input impedance of the resonance system is measured in a state in which the rectifier and the power storage device are disconnected from the secondary coil unit, while the terminal resistor is connected by the switch to the secondary coil unit. This enables accurate distance detection. Accordingly, the distance between the resonance coil at the power supplying side (i.e., primary resonance coil) and the resonance coil at the power receiving side installed in the movable body (i.e., secondary resonance coil) is accurately detected to efficiently supply power from the power supplying side to the power receiving side.

### BRIEF DESCRIPTION OF DRAWINGS

FIG. 1 is a schematic diagram showing a resonance type non-contact power supply system according to one embodiment of the present invention;

FIG. 2 is a circuit diagram showing part of the system of FIG. 1; and

FIG. 3 is a circuit diagram showing part of a resonance type non-contact power supply system according to a further embodiment of the present invention.

### DESCRIPTION OF EMBODIMENTS

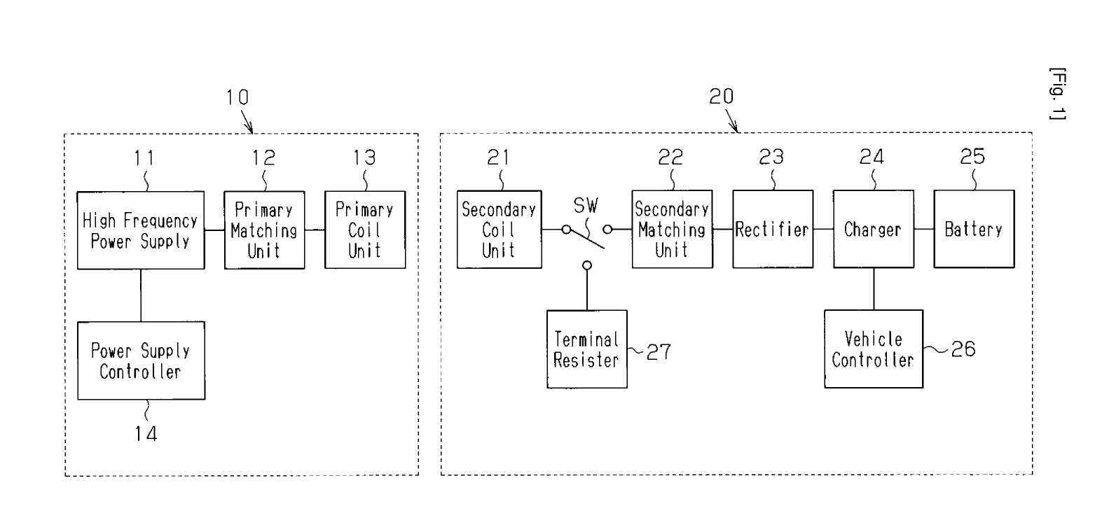

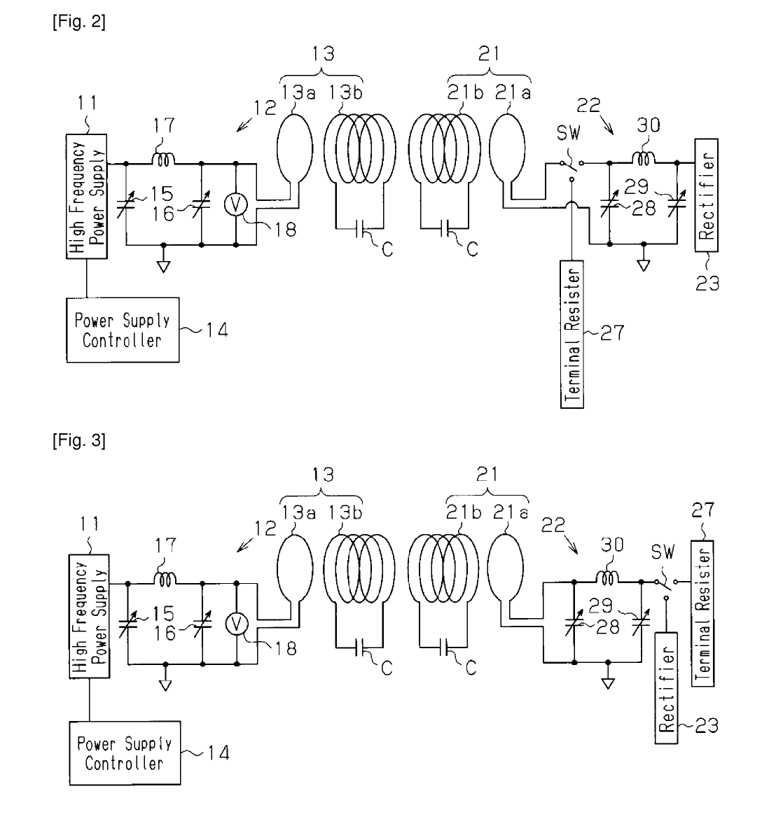

A resonance type non-contact power supply system according to one embodiment of the present invention will now be described with reference to FIGS. 1 and 2.

Referring to FIG. 1, the resonance type non-contact power supply system includes power supplying equipment 10 (power transmitting equipment), which is arranged on the ground, and movable body equipment 20, which is installed in a vehicle that serves as a movable body.

The power supplying equipment 10 includes a high frequency power supply 11, which serves as an AC power supply, a primary matching unit 12, a primary coil unit 13, and a power supply controller 14. The power supply controller 14 provides the high frequency power supply 11 with a power on/off signal to activate and deactivate the high frequency power supply 11. The high frequency power supply 11 outputs AC power at a frequency that is the same as a resonant frequency set beforehand for a resonance system. The high frequency power supply 11 outputs high frequency power having a frequency of, for example, several megahertz.

Referring to FIG. 2, the primary coil unit 13 includes a primary coil 13a and a primary resonance coil 13b. The primary matching unit 12 connects the primary coil 13a to the high frequency power supply 11. The primary coil 13a is coaxial with the primary resonance coil 13b, and a capacitor C is connected in parallel to the primary resonance coil 13b. The primary coil 13a is coupled by electromagnetic induction to the primary resonance coil 13b. AC power supplied from the high frequency power supply 11 to the primary coil 13a is further supplied through electromagnetic induction to the primary resonance coil 13b.

As shown in FIG. 2, the primary matching unit 12 includes two variable capacitors 15 and 16 and an inductor 17, which form a variable reactance. The variable capacitor 15 is connected in parallel to the high frequency power supply 11. The variable capacitor 16 is connected in parallel to the primary coil 13a. The inductor 17 is connected between the two variable capacitors 15 and 16. The primary matching unit 12 varies the capacitance of each of the variable capacitors 15 and 16 to change its impedance. The variable capacitors 15 and 16 are known configuration in which rotational shafts (not shown) are driven by motors. The motors are driven in accordance with a drive signal from the power supply controller 14.

A voltage sensor 18, which serves as an input impedance measurement unit, is connected in parallel to the primary coil 13a.

The power supply controller 14 includes a CPU and a memory. The memory stores a map or relationship expression obtained from data showing the relationship of the distance between the primary resonance coil 13b and a secondary resonance coil 21b and an input impedance of the resonance system when the high frequency power supply 11 outputs alternating current at a predetermined frequency. The data is obtained beforehand through experiments. During distance detection, the power supply controller 14 detects the voltage across the two terminals of the primary coil 13a with the voltage sensor 18 to measure the input impedance. Based on the detected input impedance and the map or relationship expression, the power supply controller 14 computes the distance between the primary and secondary resonance coils 13b and 21b. The power supply controller 14 functions as a distance computer. Further, the power supply controller 14 and the voltage sensor 18 form a distance detector.

As shown in FIG. 1, the movable body equipment 20 includes a secondary coil unit 21, a secondary matching unit 22, a rectifier 23, a charger 24, a rechargeable battery 25, which is connected to the charger 24 and which serves as a power storage device, a vehicle controller 26, and a terminal resistor 27. A switch SW selectively connects the secondary coil unit 21 to the terminal resistor 27 or the secondary matching unit 22. More specifically, the switch SW switches between a state in which the terminal resistor 27 is connected to the secondary coil unit 21 while the secondary matching unit 22, rectifier 23, charger 24, and rechargeable battery 25 are disconnected from the secondary coil unit 21 and a state in which the secondary matching unit 22, rectifier 23, charger 24, and rechargeable battery 25 are connected to the secondary coil unit 21 while the terminal resistor 27 is disconnected from the secondary coil unit 21.

As shown in FIG. 2, the secondary coil unit 21 includes a secondary coil 21a and a secondary resonance coil 21b. The secondary coil 21a is coaxial with the secondary resonance coil 21b, and a capacitor C is connected to the secondary resonance coil 21b. The secondary coil 21a is coupled by electromagnetic induction to the secondary resonance coil 21b. AC power supplied from the primary resonance coil 13b to the secondary resonance coil 21b is further supplied through electromagnetic induction to the secondary coil 21a. The switch SW selectively connects the secondary coil 21a to the terminal resistor 27 or the secondary matching unit 22.

As shown in FIG. 2, the secondary matching unit 22 includes two variable capacitors 28 and 29 and an inductor 30, which form a variable reactance. The variable capacitor 28 is connected in parallel to the secondary coil 21a via the switch SW. The variable capacitor 29 is connected to the rectifier 23. The secondary matching unit 22 varies the capacitance of each of the variable capacitors 28 and 29 to change its impedance. A motor (not shown) drives the variable capacitors 28 and 29 in accordance with a drive signal from the vehicle controller 26.

The charger 24 includes a DC/DC converter (not shown), which converts the current rectified by the rectifier 23 into voltage that is suitable for charging the rechargeable battery 25. The vehicle controller 26 controls a switching element in the DC/DC converter of the charger 24 during charging.

The number of windings and the winding diameter of the primary coil 13a, primary resonance coil 13b, secondary resonance coil 21b, and secondary coil 21a are set in accordance with the power supplied (transmitted) from the power supplying equipment 10 to the movable body equipment 20. The switch SW is a form C contact relay. In FIGS. 1 and 2, the relay is shown as a form C contact, or contact type. However, the relay may be of a non-contact type that uses a semiconductor element.

The power supply controller 14 and the vehicle controller 26 communicate with each other through a wireless communication device. The power supply controller 14 and the vehicle controller 26 exchange necessary information during a period from when the vehicle is parked at a predetermined charging position, where the power supplying equipment 10 performs charging, to when the charging ends. A notification unit (not shown) is arranged in the vehicle to notify a driver that the distance from the vehicle to the power supplying equipment 10 is suitable for the power supplying equipment 10 to perform efficient non-contact power supply. It is preferable that the notification unit be a display allowing the driver to visually recognize when the vehicle is located at the position in which the suitable distance is obtained. The notification unit may also be a device that uses a voice to allow for audible recognition. When parking the vehicle at the charging position, the vehicle controller 26 drives the notification unit based on distance information from the power supply controller 14.

When the vehicle controller 26 detects the distance between the primary resonance coil 13b and the secondary resonance coil 21b with the power supplying equipment 10, the switch SW connects the secondary coil 21a and the terminal resistor 27. When the distance detection ends, the switch SW switches the connection of the secondary coil 21a to the secondary matching unit 22.

The operation of the resonance type non-contact power supply system will now be described.

When charging the rechargeable battery 25, which is installed in the vehicle, the vehicle must be parked at a charging position at which the secondary resonance coil 21b and the primary resonance coil 13b are separated from each other by a predetermined distance. Thus, before power is supplied from the power supplying equipment 10 to the charger 24 of the movable body equipment 20, the power supplying equipment 10 detects the distance between the secondary resonance coil 21b and the primary resonance coil 13b.

More specifically, the vehicle controller 26 switches the switch SW to a state connecting the secondary coil unit 21 and the terminal resistor 27 and notifies the power supply controller 14 of such a state. When the power supply controller 14 recognizes that the terminal resistor 27 has been connected to the secondary coil unit 21, the power supply controller 14 starts detecting the distance between the primary resonance coil 13b and the secondary resonance coil 21b. In a state in which the high frequency power supply 11 outputs AC power at a predetermined frequency, the power supply controller 14 computes the input impedance of the primary coil 13a based on the detection signal of the voltage sensor 18. Then, based on the value of the input impedance and the map or relationship expression, the power supply controller 14 detects (computes) the distance between the primary resonance coil 13b and the secondary resonance coil 21b. The distance information is transmitted to the vehicle controller 26.

Distance detection is performed even when the secondary matching unit 22, the rectifier 23, the charger 24, and the rechargeable battery 25 are present in the resonance system. However, these elements affect the impedance of the resonance system. In particular, changes in the state of charge of the rechargeable battery 25 greatly affect the impedance of the resonance system. Thus, when the secondary matching unit 22, the rectifier 23, the charger 24, and the rechargeable battery 25 are present in the resonance system, the accuracy of the distance detection decreases. However, in the present embodiment, the resonance system is connected to the terminal resistor 27, which is disconnected from these elements. Thus, these elements do not affect the impedance of the resonance system. This increases the distance detection accuracy, and the detection of the distance between the primary resonance coil 13b and the secondary resonance coil 21b becomes accurate.

The vehicle controller 26 compares the distance information from the power supply controller 14 with the distance that is suitable for efficient non-contact power supply to be performed by the power supplying equipment 10 during charging. Then, the vehicle controller 26 drives the notification unit. The driver of the vehicle checks the notification unit and stops the vehicle at a position at which the vehicle can efficiently undergo non-contact power supplying, which is performed by the power supplying equipment 10.

When the vehicle reaches the predetermined parking position, the power supply controller 14 ends the distance detection and notifies the vehicle controller 26 that distance detection has ended. When the vehicle controller 26 recognizes that the distance detection performed by the power supply controller 14 has ended, the vehicle controller 26 switches the switch SW to a state connecting the secondary coil unit 21 to the secondary matching unit 22. Then, the vehicle controller 26 notifies the power supply controller 14 of the switched connection.

Next, before charging is performed, power transmission matching is performed. That is, at the parking position of the vehicle, the primary matching unit 12 and the secondary matching unit 22 are adjusted when necessary so that the resonance state of the resonance system becomes satisfactory. Then, charging is started.

Subsequently, the high frequency power supply 11 of the power supplying equipment 10 applies AC voltage having the resonant frequency to the primary coil 13a, and the primary resonance coil 13b supplies the secondary resonance coil 21b with power through non-contact resonance. The power received by the secondary resonance coil 21b is supplied to the charger 24 via the secondary matching unit 22 and the rectifier 23 to charge the rechargeable battery 25, which is connected to the charger 24. When charging starts, the state of charge of the rechargeable battery 25 changes and the impedance changes. This changes the impedance of the resonance system from a proper state. Based on the map or relationship expression, which is stored in the memory, indicating the relationship of the state of charge of the rechargeable battery 25 and the impedance suitable for the state of charge, the vehicle controller 26 adjusts the secondary matching unit 22 so that the impedance corresponds to the state of charge. Then, charging is performed in a proper state. The vehicle controller 26 determines that charging has been completed, for example, when a predetermined time elapses from when the voltage of the rechargeable battery 25 becomes equal to a predetermined voltage. When the charging ends, the vehicle controller 26 transmits a charge completion signal to the power supply controller 14. When receiving the charge completion signal, the power supply controller 14 ends the power transmission.

The above embodiment has the advantages described below.

(1) The resonance type non-contact power supply system is provided with the power supplying equipment 10, which includes the AC power supply (high frequency power supply 11) and the primary resonance coil 13b supplied with power from the AC power supply, and the movable body equipment 20, which is supplied with power from the power supplying equipment 10 in a non-contact manner. The movable body equipment 20 includes the secondary resonance coil 21b, which is supplied with power from the primary resonance coil 13b, the rectifier 23, which rectifies the power received from the secondary resonance coil 21b, the charger 24, which is supplied with rectified power from the rectifier 23, and the power storage device (rechargeable battery 25), which is connected to the charger 24. The power supplying equipment 10 includes the distance detector, which detects the distance between the primary resonance coil 13b and the secondary resonance coil 21b. The movable body equipment 20 includes the terminal resistor 27, which is connectable to the secondary coil unit 21 by the switch SW. When the distance between the primary resonance coil 13b and the secondary resonance coil 21b is detected in the power supplying equipment 10, the switch SW connects the terminal resistor 27 to the secondary coil unit 21 and disconnects the rectifier 23, the charger 24, and the power storage device from the secondary coil unit 21. When the movable body equipment 20 receives power, the switch SW connects the rectifier 23, the charger 24, and the power storage device to the secondary coil unit 21 and disconnects the terminal resistor 27 from the secondary coil unit 21. Accordingly, the power supplying side accurately detects the distance between the primary resonance coil 13b, which is located at the power supplying side, and the secondary resonance coil 21b, which is arranged in the movable body that serves as the power receiving side. Thus, power is efficiently supplied from the power supplying side to the power receiving side.

(2) During distance detection, the switch SW electrically connects the secondary coil unit 21 directly to the terminal resistor 27. Accordingly, in comparison to when the secondary matching unit 22 is arranged between the secondary coil unit 21 and the terminal resistor 27, during the distance detection, the accuracy for measuring the input impedance of the resonance system is improved.

(3) The power supplying equipment 10 includes the primary matching unit 12, and the movable body equipment 20 includes the secondary matching unit 22. Accordingly, after detection of the distance between the primary resonance coil 13b and the secondary resonance coil 21b, when power is supplied from the power supplying equipment 10 to the movable body equipment 20 to charge the rechargeable battery 25, the primary matching unit 12 and the secondary matching unit 22 are adjusted when necessary to adjust the resonance system to a satisfactory resonance state.

(4) The vehicle in which the movable body equipment 20 is installed includes the notification unit, which notifies the driver when the distance detected by the power supplying equipment 10 is suitable for efficiently receiving power in a non-contact manner from the power supplying equipment. Accordingly, the driver can easily move the vehicle and park it at the charging position.

It should be apparent to those skilled in the art that the present invention may be embodied in many other specific forms without departing from the spirit or scope of the invention. Particularly, it should be understood that the present invention may be embodied in the following forms.

During distance detection, the switch SW does not necessarily have to electrically connect the secondary coil unit 21 directly to the terminal resistor 27, and the secondary matching unit 22 may be arranged between the switch SW and the secondary coil unit 21. For example, as shown in FIG. 3, the switch SW may switch the secondary matching unit 22 to a state connected to the terminal resistor 27 and to a state connected to the rectifier 23. In this case, during distance detection, in the resonance system, the secondary matching unit 22 and the switch SW connect the terminal resistor 27 to the secondary coil unit 21. Further, the rectifier 23, the charger 24, and the rechargeable battery 25 are disconnected from the resonance system. In this case, during distance detection, each of the variable capacitors 28 and 29 in the secondary matching unit 22 is adjusted to the preset capacitance. However, it is more preferable that the secondary coil unit 21 be directly connected to the terminal resistor 27 during distance detection.

To perform non-contact power supplying between the power supplying equipment 10 and the movable body equipment 20, the resonance type non-contact power supply system does not necessarily require all of the primary coil 13a, the primary resonance coil 13b, the secondary coil 21a, and the secondary resonance coil 21b. The resonance type non-contact power supplying system only requires the primary resonance coil 13b and the secondary resonance coil 21b. More specifically, instead of forming the primary coil unit 13 with the primary coil 13a and the primary resonance coil 13b, the primary resonance coil 13b may be connected by the primary matching unit 12 to the high frequency power supply 11. Further, instead of forming the secondary coil unit 21 with the secondary coil 21a and the secondary resonance coil 21b, the secondary resonance coil 21b may be connected by the secondary matching unit 22 or the like to the rectifier 23. However, it is more preferable that the resonance type non-contact power supply system include all of the primary coil 13a, the primary resonance coil 13b, the secondary coil 21a, and the secondary resonance coil 21b. This facilitates adjustment of the resonance state and easily maintains a resonance state even when the distance increases between the primary resonance coil 13b and the secondary resonance coil 21b.

When the primary coil 13a is eliminated, the voltage sensor 18, which forms the distance detector, measures the voltage across the two terminals of the primary resonance coil 13b. Further, the power supply controller 14 detects the distance between the primary resonance coil 13b and the secondary resonance coil 21b from a map or relationship expression that indicates the relationship of the measured voltage and the distance between the primary resonance coil 13b and the secondary resonance coil 21b.

The primary matching unit 12 of the power supplying equipment 10 and the secondary matching unit 22 of the movable body equipment 20 may be eliminated. However, it is preferable that the primary matching unit 12 and the secondary matching unit 22 be included since power can be efficiently supplied from the power supplying side to the power receiving side when finely adjusting the impedance of the resonance system.

The vehicle, which serves as the movable body, is not limited to a vehicle that requires a driver and may be an automated vehicle.

The movable body is not limited to a vehicle and may be a robot. In such a case, the robot includes a controller that refers to data of the distance detected by the power supplying equipment 10. The controller stops the robot when the distance between the primary resonance coil 13b and the secondary resonance coil 21b becomes suitable for the power supplying equipment 10 to efficiently perform non-contact power supply.

The primary matching unit 12 and the secondary matching unit 22 each do not have to include two variable capacitors and an inductor. For example, a matching unit may include a variable inductor that serves as the inductor. Alternatively, a matching unit may include a variable inductor and two non-variable capacitors.

The high frequency power supply 11 may be formed so that the frequency of the output AC voltage is variable or invariable.

The rechargeable battery 25 may be charged without arranging a step-up circuit in the charger 24. In this case, the rechargeable battery 25 is charged just by rectifying the AC current output from the secondary coil unit 21 with the rectifier 23.

The charger 24 may be omitted from the movable body equipment 20. In this case, the power rectified by the rectifier 23 is supplied directly to the rechargeable battery 25. Whether the charger 24 is omitted or not, the power supplying equipment 10 may be configured to adjust the output power of the high-frequency power source 11.

The diameters of the primary coil 13a and secondary coil 21a do not have to be the same as the diameters of the primary resonance coil 13b and the secondary resonance coil 21b. The diameters of the primary coil 13a and secondary coil 21a may be smaller than or larger than the diameters of the primary resonance coil 13b and the secondary resonance coil 21b.

Each of the primary resonance coil 13b and secondary resonance coil 21b does not have to be a helically wound wire and may be a wire that is spirally wound on a plane.

Instead of arranging the rectifier 23 and the charger 24 independently from each other, the rectifier 23 may be incorporated in the charger 24.

The power storage device is not limited to the rechargeable battery 25 as long as it is a DC power supply that can be charged and discharged. For example, the power storage device may be a capacitor having a large capacitance.

The capacitors C connected to the primary resonance coil 13b and the secondary resonance coil 21b may be eliminated. However, connection of the capacitors C enables the resonant frequency to be decreased, whereas the resonant frequency would not be decreased when the capacitors C are eliminated. Further, as long as the resonant frequency is the same, connection of the capacitors C enables miniaturization of the primary resonance coil 13b and the secondary resonance coil 21b, whereas such miniaturization would be difficult when the capacitors C are eliminated.

The present examples and embodiments are to be considered as illustrative and not restrictive, and the invention is not to be limited to the details given herein, but may be modified within the scope and equivalence of the appended claims.

1. A resonance type non-contact power supply system that supplies power through a primary-side resonance coil and a secondary-side resonance coil, the resonance type non-contact power supply system comprising:
power supplying equipment including an AC power supply, a primary coil unit, which includes the primary resonance coil, and a distance detector, wherein the primary resonance coil receives power from the AC power supply, and the distance detector detects the distance between the primary resonance coil and the secondary resonance coil; and
movable body equipment including a secondary coil unit, which includes the secondary resonance coil, a rectifier, a power storage device, a switch, and a terminal resistor, which is connectable by the switch to the secondary coil unit;
wherein the second resonance coil receives power from the primary resonance coil, the rectifier rectifies the power received by the secondary resonance coil, and the power storage device is supplied with power rectified by the rectifier;
wherein when the distance detector detects the distance, the switch connects the terminal resistor to the secondary coil unit and disconnects the rectifier, and the power storage device from the secondary coil unit; and
when the movable body equipment receives power, the switch connects the rectifier and the power storage device to the secondary coil unit and disconnects the terminal resistor from the secondary coil unit.

2. The resonance type non-contact power supply system according to claim 1, wherein the distance detector detects the distance between the primary resonance coil and the secondary resonance coil based on an input impedance of a resonance system when the AC power supply outputs AC power, and the resonance system includes the primary coil unit and the secondary coil unit.

3. The resonance type non-contact power supply system according to claim 1, wherein the distance detector includes a voltage sensor connected in parallel to the primary coil unit.

4. The resonance type non-contact power supply system according to claim 1, wherein the movable body equipment is installed in a vehicle.

5. The resonance type non-contact power supply system according to claim 4, wherein the vehicle includes a notification unit that notifies a driver that the distance detected by the distance detector is suitable for efficiently receiving power from the power supplying equipment.

6. The resonance type non-contact power supply system according to claim 1, wherein the movable body equipment further includes a charger provided between the rectifier and the power storage device, the power rectified by the rectifier is supplied to the charger, and the power storage device is connected to the charger.
